(19) United States
(12) Patent Application Publication
(10) Pub. No.: US 2003/0018669 A1
(43) Pub. Date: Jan. 23, 2003

(54) System and method for associating a destination document to a source document during a save process

(75) Inventor: Reiner Kraft, Gilroy, CA (US)

Correspondence Address: Samuel A. Kassatly, 6819 Trinidad Drive, San Jose, CA, 95120, US

(73) Assignee: International Business Machines Corporation

(21) Appl. No.: 09/825,210

(22) Filed: Apr. 2, 2001

(51) Int. Cl. G06F 17/21

(52) U.S. Cl. 707/530; 707/501.1

(57) ABSTRACT

A computer program product is provided as a system and associated method for use with an operating system, a web browser and the Internet, to save the location and other context information along with the content of a web page or document when the document is saved to a computer hard disk or another storage medium. The system saves the location of the source document, query parameter, and other relevant input information as attributes of the saved document. The system also provides a mechanism whereby the user may synchronize stored documents with web document. In addition, the system allows the user to return to the source document if a target or intermediary document is deleted.

### FIELD OF THE INVENTION

The present invention relates to the field of data processing, and particularly to a software system and associated method for use with computers and documents on the Internet. More specifically, this invention relates to a system for saving the content of a target document bundled with contextual metadata, such as the location of a source document, as attributes of the target document.

### BACKGROUND OF THE INVENTION

The World Wide Web (WWW) is comprised of an expansive network of interconnected computers upon which businesses, governments, groups, and individuals throughout the world maintain inter-linked computer files known as web pages. Users navigate these pages by means of computer software programs commonly known as Internet browsers. Due to the vast number of WWW sites, many web pages have a redundancy of information or share a strong likeness in either function or title. The vastness of the unstructured WWW causes users to rely primarily on Internet search engines to retrieve information or to locate businesses. These search engines use various means to determine the relevance of a user-defined search to the information retrieved.

The authors of web pages provide information known as Metadata within the body of the hypertext markup language (HTML) document that defines the web pages. A computer software product known as a web crawler systematically accesses web pages by sequentially following hypertext links from page to page. The crawler indexes the pages for use by the search engines using information about a web page as provided by its address or Universal Resource Locator (URL), Metadata, and other criteria found within the page. The crawler is run periodically to update previously stored data and to append information about newly created web pages. The information compiled by the crawler is stored in a Metadata repository or database. The search engines search this repository to identify matches for the user-defined search rather than attempt to find matches in real time.

A typical search engine has an interface with a search window where the user enters an alphanumeric search expression or keywords. The search engine sifts through available web sites for the user's search terms, and returns the search of results in the form of HTML pages. Each search result includes a list of individual entries that have been identified by the search engine as satisfying the user's search expression. Each entry or “hit” may include a hyperlink that points to a Uniform Resource Locator (URL) location or web page.

In this web browsing environment, users are able to save documents embedded in web based documents represented through the URL to a user specified location such as a computer hard drive. Web pages typically contain hyperlinks in the form of underlined or highlighted text linking to various other documents on the Internet. With currently available web browsers, users are able to save the target document of such hyperlinks to either the local file system of their personal computer or to a different network location.

This is accomplished by using a pointing device such as a mouse to select the hyperlink (typically using the right mouse button) then choosing the “save target as” entry to copy and save the document target to a different location. However, once the document is saved, the Internet (or hyperlink) context is lost. Consequently, the user will not be able to return from the saved document to the original referral page from which the document was saved, nor would it be possible for the user to return to the download location of the document, since this information is also lost during the save process.

Currently, technology exists which allows the user to scan and map dynamically generated Web documents by capturing the data entered by the user into a web-based form and storing this data and form in association with the Web document. The Web document may then be displayed by presenting the current version of the dynamically generated document to the user with the browser program to create the impression of normal browsing during the capture session. Reference is made to U.S. Pat. No. 5,958,008 to Pobrebisky, et. al. However, this technology primarily addresses the mapping of web site links and does not address the needs that are inherent in document storage, such as the ability to save and store a web document as a separate document file while also storing location references and other Internet context information.

Thus, there is need for a system capable of saving Web documents locations and other Internet context information in addition to the content of Web documents. The need for such a system and associated method has heretofore remained unsatisfied.

### SUMMARY OF THE INVENTION

The document association system and method of the present invention satisfy this need by bundling or associating a target document (i.e., a web page) and the context of a source document as metadata to the target document during a save process. Accordingly, users will be able to return to the source document, and optionally to use applications for automatically synchronizing a destination document to the target document.

The context of the source document may include, for example, one or more of the following parameters:

The location or address, such as the URL, of the source document;

the path, such as pages examined to navigate from the source document to the target document; and

the input parameters required to generate the target document, such as the search query inputted by the user.

The document association system of the present invention can function on the level of the operating system (e.g. Windows®, Linux®, etc.) in conjunction with a web browser environment. When a user wishes to access the source document, the system uses the saved context metadata to link the user to the source document. Optionally, the system is capable to synchronizing the target document to the destination document.

In one embodiment, the user selects a destination document using the right button on a mouse, displaying the URLs of the source document location, path, and input parameters displayed in a pop up menu. The user then selects the desired URL for the web browser to execute the hyperlink of the associated source document.

When coupled with a synchronization application, the system of the invention allows the user to update the destination document to reflect changes in the target document, allowing a convenient mechanism for updating saved documents. The synchronization application performs a comparison of the destination document with the target document to detect changes and to automatically update the destination document. If the target document were deleted from its original location or relocated, the destination document is marked as orphaned. However, the user is still able to return to the source document.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a document association system of the present invention can be used;

FIG. 2 is a high level system architecture of the document association system of FIG. 1;

FIG. 3 is a flow chart representative of an exemplary method of operation of the document association system of FIGS. 1 and 2;

FIG. 4 shows an exemplary web page with embedded document URLs using the document association system of FIGS. 1 and 2;

FIG. 5 shows a web page with the right mouse click to activate a “save target as” pop-up menu for a desired destination document created by means of the document association system of FIGS. 1 and 2;

FIG. 6 shows the file attributes for the destination document of FIG. 6; and

FIG. 7 shows extended metadata information for the destination document of FIG. 6.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Crawler: A program that automatically explores the World Wide Web by retrieving a document and recursively retrieving some or all the documents that are linked to it.

Destination document: A final document or web page which is comprised of a target document that is bundled with contextual data about the source document.

HTML (Hypertext Markup Language): A standard language for attaching presentation and linking attributes to informational content within documents. During a document authoring stage, HTML “tags” are embedded within the informational content of the document. When the web document (or “HTML document”) is subsequently transmitted by a web server to a web browser, the tags are interpreted by the browser and used to parse and display the document. In addition to specifying how the web browser is to display the document, HTML tags can be used to create hyperlinks to other web documents.

Intermediate document: An intermediate document or web page to which a source document points, whether directly or indirectly, and which, in turn, points to a target document, whether directly or indirectly.

Internet: A collection of interconnected public and private computer networks that are linked together with routers by a set of standards protocols to form a global, distributed network.

Search engine: A remotely accessible World Wide Web tool that allows users to conduct keyword searches for information on the Internet.

Server: A software program or a computer that responds to requests from a web browser by returning (“serving”) web documents.

Source document: An initial document or web page that points, whether directly or indirectly, to a target document and/or to a destination document.

Target document: A special intermediate document or web page that points directly to a destination document.

URL (Uniform Resource Locator): A unique address that fully specifies the location of a content object on the Internet. The general format of a URL is protocol://server-address/path/filename.

Web browser: A software program that allows users to request and read hypertext documents. The browser gives some means of viewing the contents of web documents and of navigating from one document to another.

Web document or page: A collection of data available on the World Wide Web and identified by a URL. In the simplest, most common case, a web page is a file written in HTML and stored on a web server. It is possible for the server to generate pages dynamically in response to a request from the user. A web page can be in any format that the browser or a helper application can display. The format is transmitted as part of the headers of the response as a MIME type, e.g. “text/html”, “image/gif”. An HTML web page will typically refer to other web pages and Internet resources by including hypertext links. A web page or document can be dynamic or static. A dynamic page is dependent on input parameters such as query parameters, while a static page is not dependent on input parameters.

Web Site: A database or other collection of inter-linked hypertext documents (“web documents” or “web pages”) and associated data entities, which is accessible via a computer network, and which forms part of a larger, distributed informational system such as the WWW. In general, a web site corresponds to a particular Internet domain name, and includes the content of a particular organization. Other types of web sites may include, for example, a hypertext database of a corporate “intranet” (i.e., an internal network which uses standard Internet protocols), or a site of a hypertext system that uses document retrieval protocols other than those of the WWW.

World Wide Web (WWW): An Internet client—server hypertext distributed information retrieval system.

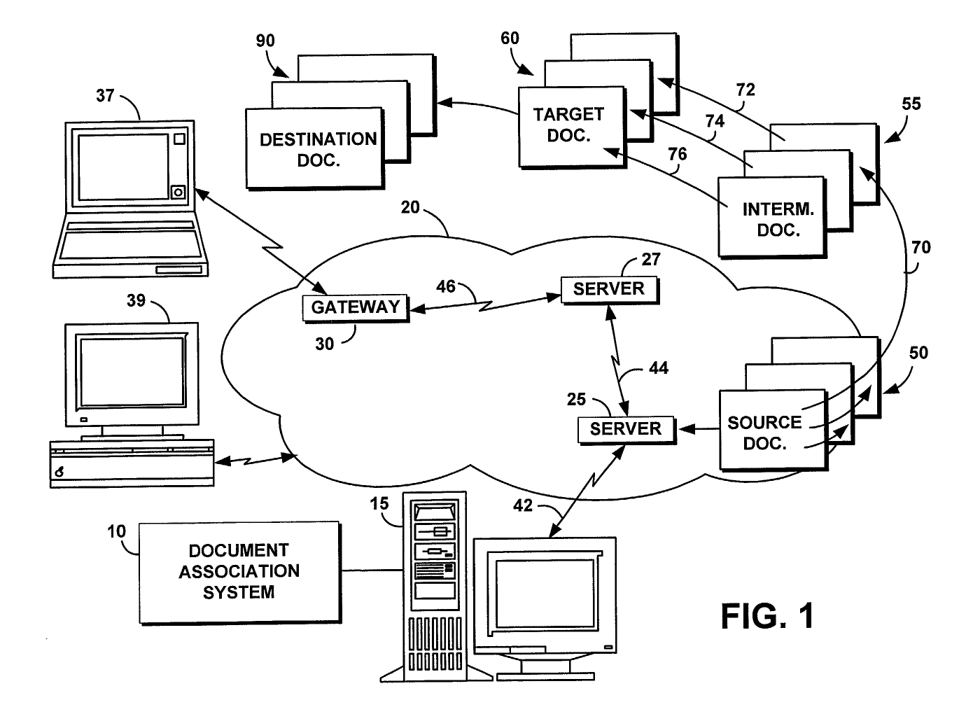

FIG. 1 portrays an exemplary overall environment in which a document association system 10 of the present invention may be used. The system 10 includes a software or computer program product that is typically embedded within, or installed, at least in part, on a host server 15. Alternatively, the system 10 can be saved on a suitable storage medium such as a diskette, a CD, a hard drive, or like devices. While the system 10 will be described in connection with the WWW, the system 10 can be used with a stand-alone database of documents that may have been derived from the WWW and/or other sources.

The cloud-like communication network 20 is comprised of communication lines and switches connecting servers such as servers 25, 27, to gateways such as gateway 30. The servers 25, 27 and the gateway 30 provide the communication access to the WWW Internet. Users, such as remote Internet users are represented by a variety of computers such as computers 37, 39, and can query the host server 15 for the desired information.

The host server 15 is connected to the network 20 via a communications link such as a telephone, cable, or satellite link. The servers 25, 27 can be connected via high speed Internet network lines 44, 46 to other computers and gateways. The servers 25, 27 provide access to stored information such as hypertext or web documents indicated generally at 50, 55, and 60. The hypertext documents 50 (source document), 55 (intermediate document), 60 (target document) most likely include embedded hypertext links to other locally stored pages, and hypertext links 70, 72, 74, 76 to other webs sites or documents 55, 60 that are stored by various web servers such as the server 27.

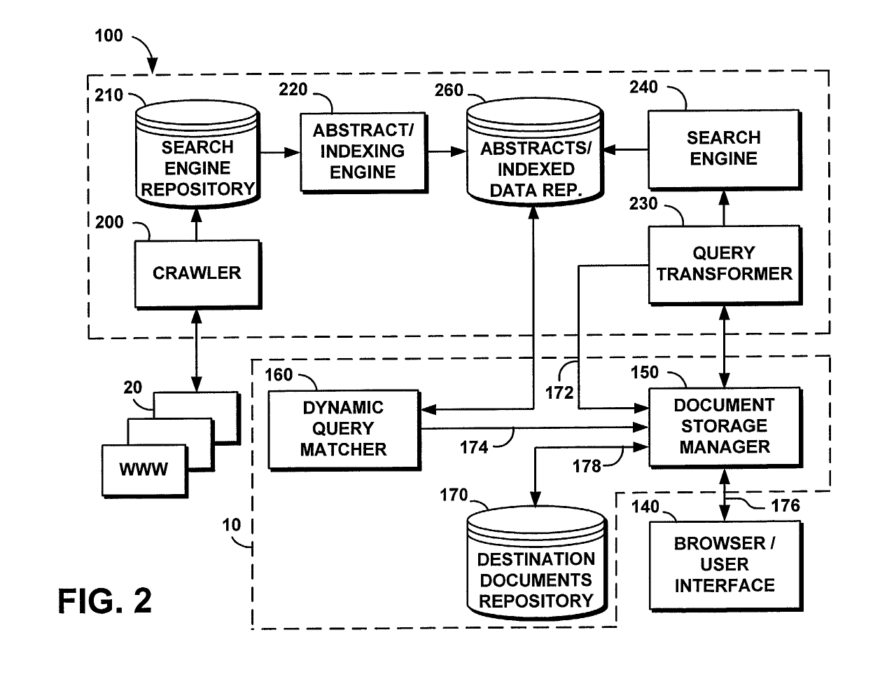

FIG. 2 illustrates an exemplary high level architecture showing the document association system 10 of FIG. 1 used in the context of an Internet search. Though the system 10 is illustrated and described herein in the context of an Internet search, it should be amply clear that the system 10 may be used in various other applications, such as in a simple browsing environment.

The system 10, transparently to the user, continuously or periodically operates in the background. While the service provider 100 and the system 10 are illustrated herein as being separate, it should be clear that these two components can be functionally combined as part of the service provider 100. Alternatively, the system 10 can constitute either of the user's computer and/or the service provider 100.

The system 10 includes the following components: a user module also referred to herein as a document storage manager 150, a server module also referred to herein as dynamic query matcher 160, and a destination documents repository 170 where destination documents 90 (FIG. 1) are stored. As it will be explained later in greater detail, the documents storage manager 150 receives the following information:

Input parameters 172, such as query parameters for a dynamic document, from a query transformer 230;

URL 174 of a source document (i.e., 50 in FIG. 1) from the dynamic query matcher 160 (or from the service provider 100);

destination URL 176, such as the address of the destination documents repository 170; and

content 178 of target document (i.e., 60 in FIG. 1).

The documents storage manager 150 is responsible for bundling the content 178 of the target document 60 and the contextual data related to the source document 50, and to save the newly bundled document as destination document 90 in the destination documents repository 170. The contextual data include, for example, the input parameters 172, the destination URL 176, and the URL 174 of the source document 50.

In use, the client session query, including the input parameters 172, is forwarded to the service provider 100 for normal query processing, whereupon the service provider 100 forwards the search results to the system 10 for further processing. The query and query results can be stored, for example in the destination documents repository 170 or in any other data storage system, whether on the user's side, the service provider's 100, or an independent network storage repository for later use by the document storage manager 150.

According to one embodiment, the service provider 100 is generally comprised of a web crawler 200, a search engine repository 210, an abstract/indexing engine 220, a query transformer 230, a search engine 240, and an abstracts/indexed data repository 260. Optionally, the search service provider 100 includes a search results transformer (not shown). Alternatively, the search results transformer can be combined with the document storage manager 150 of the system 10.

In operation, the crawler 150 crawls the WWW 20 and downloads web documents to the search engine repository 210 where they are stored and updated systematically. The abstract/indexing engine 220 indexes the web documents and generates abstracts therefrom. The abstracts and the indexed data are stored in the abstracts/indexed data repository 260 for later use by the search engine 240, as appropriate.

The search engine repository 210 is a data store which is maintained by a web information gatherer such as the web crawler 200. The search engine repository 210 maintains information or metadata from previously encountered web pages, which metadata is used by the abstract/indexing engine 220 to prepare the abstracts. Preferably, the search engine repository 210 is maintained centrally by the service provider 100. Alternatively, the search engine repository 210 may be located and maintained on an independently provided system to which the service provider 100 has access. In addition, while the system 10 is described as including two repositories 210 and 260, it should be clear these two repositories 210 and 260 could be functionally combined in a single database.

The abstract/indexing engine 220 generates an abstract for each web document from the metadata stored in the search engine repository 210. While the abstract/indexing engine 220 is illustrated in FIG. 2 as being a single component, it should be clear that the abstract/indexing engine 220 could be functionally separated into two distinct engines: an abstract engine and an indexing engine.

The query transformer 230, prompted by the user browser 140, applies an internal query request to the abstracts/indexed data stored in the abstracts/indexed data repository 260, and generates a search result with matches (or search results) that are specific to the user's query. The search results 270 are transformed into viewable or browsable form (i.e., HTML) by the query transformer 230, and the transformed data is subsequently presented to the user at the user interface (UI) or browser 140.

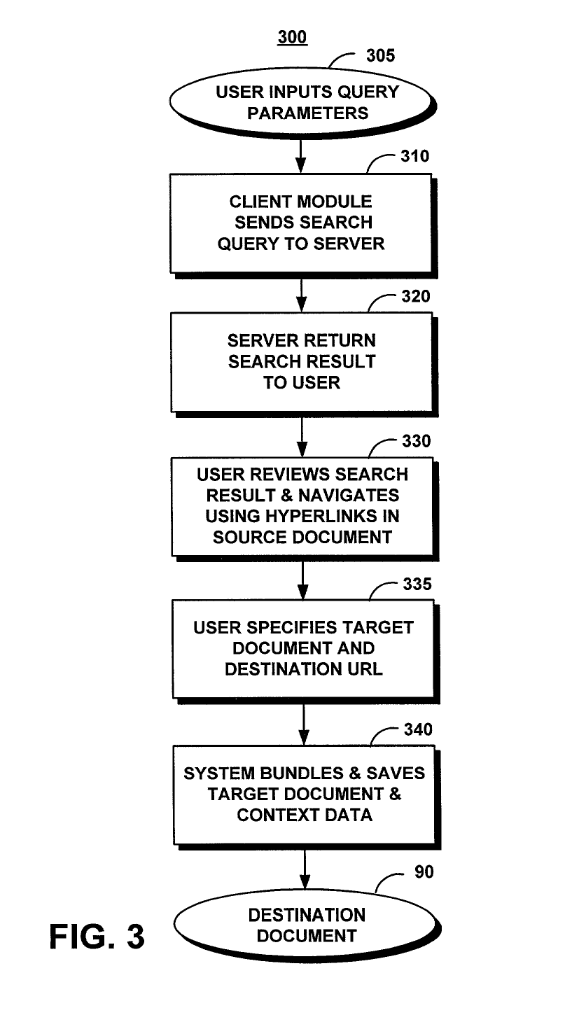

The method of operation 300 of the system 10 will now be briefly summarized in connection with FIG. 3. At step 305 of method 300, the user inputs query parameters 172 (FIG. 2) using the browser 140. At step 310, the document storage manager (otherwise referred to as client module) 150 sends the search query to the service provider (also referred to herein as server) 100.

Whereupon, at step 320 the service provider 100 returns the search results to the user's web browser 140 as the source document, and establishes a connection with the system 10. The user reviews the search results at step 330, and, at step 335, the user navigates the Internet using the hyperlinks 70, 72, 74, 76 in the source document 50 and the intermediate document or documents 55 (FIG. 1).

The user continues his or her navigation until he or she detects the desired target document 60 (FIG. 1). At which point, the user identifies such target document 60, issues a save command, and enters the destination address (URL) 176 of the destination documents repository 170 where he or she desires to store the destination document 90 (FIG. 1). The destination documents repository 170 can be located on the user's computer, on the network 20, and/or within the service provider 100.

At step 340, the save command prompts the system 10 and more specifically the document storage manager 150 to create the destination document 90 by bundling the target document 60 with the context data of the source document 50, as explained earlier.

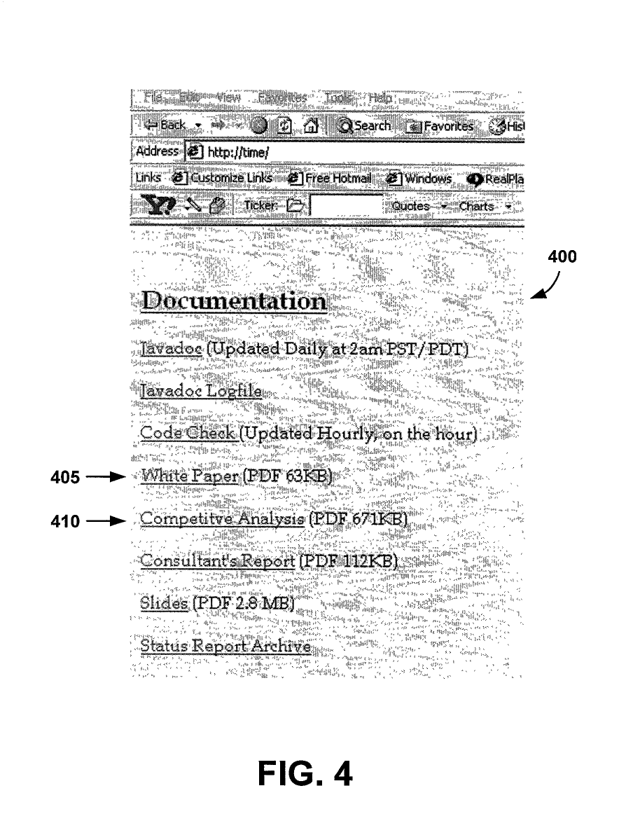

A specific example will assist in further clarifying the operation of the system 10. FIG. 4 shows an exemplary, partial screen shot of a source document such as an HTML page 400 that contains hyperlinks to various other documents in the form of underlined and highlighted text, i.e., 405 and 410. In this example, a target document titled “White Paper” is referenced by an embedded hyperlink 405 pointing to http://time/pdfNVhitePaper.pdf.

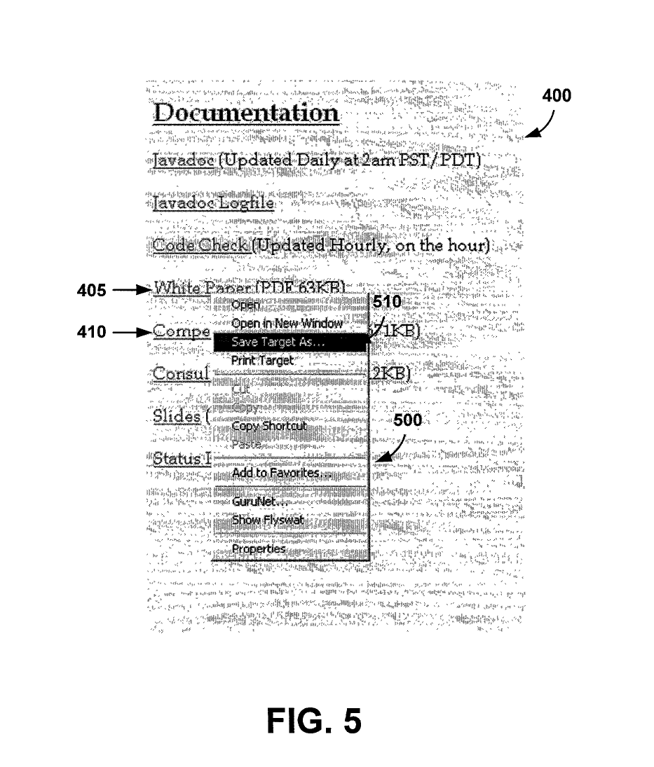

With reference to FIG. 5, the user can save this target document to a hard drive or another storage medium by using a pointing device, such as a mouse, to select the hyperlink (typically using the right mouse button or “click and hold”), then selecting the “save target as” command 510 from a pop up menu 500. As explained earlier, the target document “White Paper” is bundled with context attributes and saved as a destination document that resides on the selected storage medium as a pdf document.

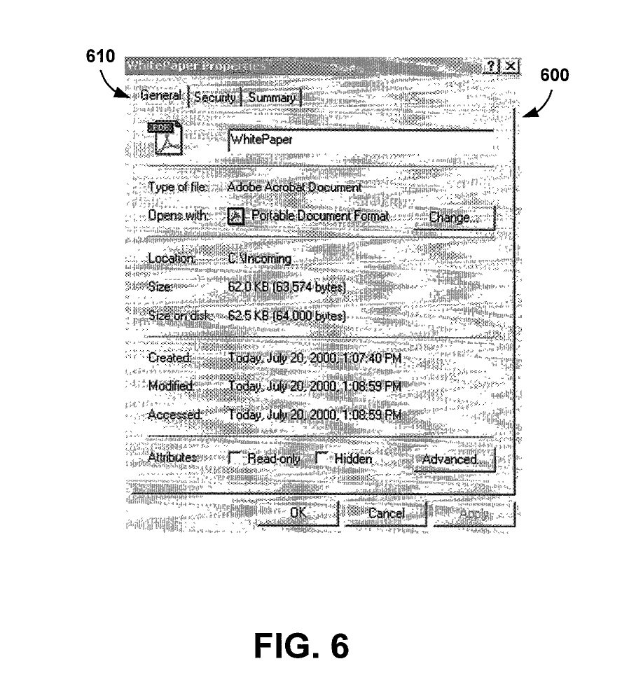

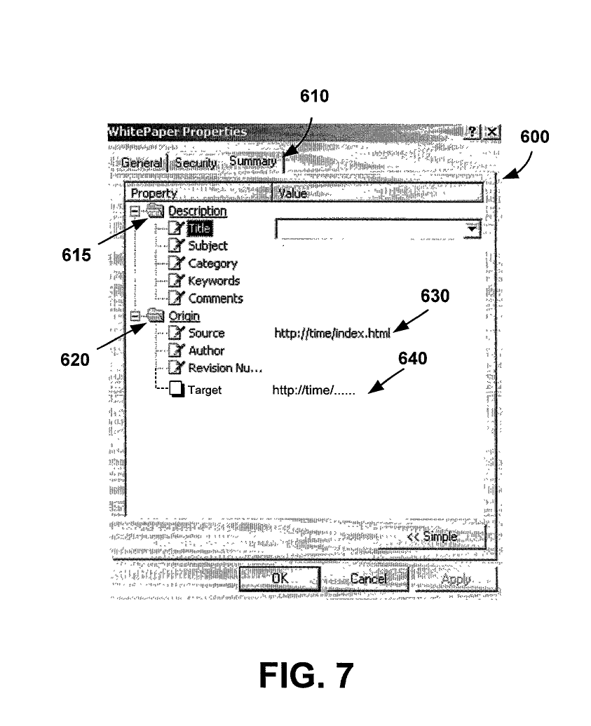

FIG. 6 illustrates the document properties 600 for the destination document. The General attributes tab 610 for the target document displays the file type, document size, etc. In addition, and as further illustrated in FIG. 7, the system 10 of the present invention provides additional attributes in the Summary attribute 165. The document Description folder 615 remains the same as provided by the operating system and the document application.

Specific exemplary attributes (or context data) added by the system 10 are shown under the Origin folder 620 as Source, Author, Revision Number, and Target, where the Source refers to the URL 630 of the source document, and Target refers to the URL 640 of the target document. When clicked, the URL 630 of the source document, i.e., http://time/index.html will return the user to the source document, thus making access the source document readily available to the user.

It is to be understood that the specific embodiments of the present invention that have been described are merely illustrative of certain application of the principle of the present invention. Numerous modifications may be made to the document association system and method without departing from the spirit and scope of the present invention. Moreover, while the present invention is described for illustration purpose only in relation to the WWW, it should be clear that the invention is applicable as well to databases and other tables with indexed entries.

What is claimed is:

1. A method of associating a destination document to a source document during a save operation, comprising:
defining contextual metadata of the source document, wherein the contextual metadata includes a location of the source document;
identifying a target document;
bundling the target document, and the contextual metadata of the source document as attributes of the target document; and
saving a bundled target document as the destination document.

2. The method of claim 1, wherein identifying the target document includes identifying the target document by a content and contextual data.

3. The method of claim 2, wherein bundling the target document includes merging the contextual metadata of the source document and the contextual data of the target document as integral attributes of the target document.

4. The method of claim 3, further including automatically synchronizing the destination document to the target document.

5. The method of claim 3, wherein defining the contextual metadata of the source document includes defining the address of the source document.

6. The method of claim 5, wherein defining the address of the source document includes identifying a URL of the source document.

7. The method of claim 5, wherein defining the contextual metadata of the source document further includes defining a navigation path from the source document to the target document.

8. The method of claim 5, wherein defining the contextual metadata of the source document further includes defining input parameters required to generate the target document.

9. The method of claim 8, wherein defining the input parameters includes defining an input search query.

10. The method of claim 5, wherein saving the bundled target document includes saving the destination document on a networked data repository.

11. A system for associating a destination document to a source document during a save operation, comprising:
an application that defines contextual metadata of the source document, wherein the contextual metadata includes a location of the source document;
a processor that bundles a target document with the contextual metadata of the source document, as attributes of the target document; and
a repository for storing a bundled target document as the destination document.

12. The system of claim 11, wherein the target document is identified by a content and contextual data.

13. The system of claim 12, wherein the processor bundles the target document includes by merging the contextual metadata of the source document and the contextual data of the target document as integral attributes of the target document.

14. The system of claim 13, further including an application that automatically synchronizes the destination document to the target document.

15. The system of claim 13, wherein the contextual metadata of the source document includes the address of the source document.

16. The system of claim 15, wherein the address of the source document includes a URL of the source document.

17. The system of claim 15, wherein the contextual metadata of the source document further includes a navigation path from the source document to the target document.

18. The system of claim 15, wherein the contextual metadata of the source document further includes input parameters required to generate the target document.

19. The system of claim 18, wherein the input parameters include an input search query.

20. A software program for associating a destination document to a source document during a save operation, comprising:
means for defining contextual metadata of the source document, wherein the contextual metadata includes a location of the source document;
means for bundling a target document with the contextual metadata of the source document, as attributes of the target document; and
means for saving a bundled target document as the destination document.
